(19) United States
(12) Patent Application Publication
(10) Pub. No.: US 2006/0274925 A1
(43) Pub. Date: Dec. 7, 2006

(54) Generating a volume of interest using a dose isocontour

(76) Inventors: Jay B. West, Mountain View, CA (US); Hongwu Wang, Milpitas, CA (US); John R. Dooley, Castro Valley, CA (US)

Correspondence Address: ACCURAY/BLAKELY, 12400 WILSHIRE BOULEVARD, SEVENTH FLOOR, LOS ANGELES, CA, 90025-1030, US

(21) Appl. No.: 11/145,121

(22) Filed: Jun. 2, 2005

(51) Int. Cl. G06K 9/00

(52) U.S. Cl. 382/131

(57) ABSTRACT

An apparatus and method of automatically optimizing a dose isocontour using a volume of interest.

### TECHNICAL FIELD

This invention relates to the field of radiation treatment planning and, in particular, to the generation a dose isocontour in treatment planning.

### BACKGROUND

A tumor is an abnormal growth of tissue resulting from the uncontrolled, progressive multiplication of cells, serving no physiological function. A tumor may be malignant (cancerous) or benign. A malignant tumor is one that spreads cancerous cells to other parts of the body (metastasizes) through blood vessels or the lymphatic system. A benign tumor does not metastasize, but can still be life-threatening if it impinges on critical body structures such as nerves, blood vessels and organs (especially the brain).

A non-invasive method for tumor treatment is external beam radiation therapy. In one type of external beam radiation therapy, an external radiation source is used to direct a sequence of x-ray beams at a tumor site from multiple angles, with the patient positioned so the tumor is at the center of rotation (isocenter) of the beam. As the angle of the radiation source is changed, every beam passes through the tumor site, but passes through a different area of healthy tissue on its way to the tumor. As a result, the cumulative radiation dose at the tumor is high and the average radiation dose to healthy tissue is low. The term radiotherapy refers to a procedure in which radiation is applied to a target region for therapeutic, rather than necrotic, purposes. The amount of radiation utilized in radiotherapy treatment sessions is typically about an order of magnitude smaller, as compared to the amount used in a radiosurgery session. Radiotherapy is typically characterized by a low dose per treatment (e.g., 100-200 centiGray (cGy)), short treatment times (e.g., 10 to 30 minutes per treatment) and hyperfractionation (e.g., 30 to 45 days of treatment). For convenience, the term “radiation treatment” is used herein to mean radiosurgery and/or radiotherapy unless otherwise noted by the magnitude of the radiation.

Conventional isocentric radiosurgery systems (e.g., the Gamma Knife) use forward treatment planning. That is, a medical physicist determines the radiation dose to be applied to a tumor and then calculates how much radiation will be absorbed by critical structures and other healthy tissue. There is no independent control of the two dose levels, for a given number of beams, because the volumetric energy density at any given distance from the isocenter is a constant, no matter where the isocenter is located.

Inverse planning, in contrast to forward planning, allows the medical physicist to independently specify the minimum tumor dose and the maximum dose to other healthy tissues, and lets the treatment planning software select the direction, distance, and total number and energy of the beams. Conventional treatment planning software packages are designed to import 3-D images from a diagnostic imaging source, for example, magnetic resonance imaging (MRI), positron emission tomography (PET) scans, angiograms and computerized x-ray tomography (CT) scans. These anatomical imaging modalities such as CT are able to provide an accurate three-dimensional model of a volume of interest (e.g., skull or other tumor bearing portion of the body) generated from a collection of CT slices and, thereby, the volume requiring treatment can be visualized in three dimensions.

During inverse planning, a volume of interest (VOI) is used to delineate structures to be targeted or avoided with respect to the administered radiation dose. That is, the radiation source is positioned in a sequence calculated to localize the radiation dose into a VOI that as closely as possible conforms to the tumor requiring treatment, while avoiding exposure of nearby healthy tissue. Once the target (e.g., tumor) VOI has been defined, and the critical and soft tissue volumes have been specified, the responsible radiation oncologist or medical physicist specifies the minimum radiation dose to the target VOI and the maximum dose to normal and critical healthy tissue. The software then produces the inverse treatment plan, relying on the positional capabilities of radiation treatment system, to meet the min/max dose constraints of the treatment plan.

The two principal requirements for an effective radiation treatment system are conformality and homogeneity. Homogeneity is the uniformity of the radiation dose over the volume of the target (e.g., pathological anatomy such as a tumor, legion, arteriovenous malformation, etc.) characterized by a dose volume histogram (DVH). An ideal DVH would be a rectangular function, where the dose is 100 percent of the prescribed dose over the volume of the tumor and zero elsewhere.

Conformality is the degree to which the radiation dose matches (conforms) to the shape and extent of the target (e.g., tumor) in order to avoid damage to critical adjacent structures. More specifically, conformality is a measure of the amount of prescription (Rx) dose (amount of dose applied) within a target VOI. Conformality may be measured using a conformality index (CI)=total volume at>=Rx dose/target volume at>=Rx dose. Perfect conformality results in a CI=1. With conventional radiotherapy treatment, using treatment planning software, a clinician identifies a dose isocontour for a corresponding VOI for application of a treatment dose (e.g., 2000 cGy).

FIG. 1 illustrates the graphical output of treatment planning software displaying a CT slice of a spine containing pathological anatomy (e.g., tumor, legion, arteriovenous malformation, etc.) region and normal anatomy as a critical region to be avoided (e.g., internal organ). The treatment planning software enables the generation of a critical region contour, a target (i.e., pathological anatomy) region contour, and a dose isocontour on displayed CT slice.

Conventionally, a user manually delineates points on the display that is used by the treatment planning software to generate a corresponding contour. Ideally, the 100% dose isocontours for all of the slices should match the target region (e.g., tumor) over its 3 dimensional volume. While this may seem an easy task, such matching is difficult due the 3 dimensional nature and irregularities of the pathological and normal anatomies. As such, a given inverse plan developed by the treatment planning software may be unsatisfactory because of lack of conformality, i.e., the dose isocontours representing a given dose percentage does not fit tightly enough to the boundary of the targeted treatment area (e.g., tumor or lesion). The conventional method to produce more conformality involves a manual procedure whereby a user either (1) attempts to manually draw a dose isocontour that results in greater conformality, or (2) manually delineates constraint points (e.g., points 1, 2, 3 and 4 of FIG. 1) within a dose isocontour that encourages an optimization routine in the treatment planning software to bring the isocontour boundary closer to the surface of the target. However, such manual tasks are time consuming and may not result in optimum conformality.

### BRIEF DESCRIPTION OF THE DRAWINGS

The present invention is illustrated by way of example, and not by way of limitation, in the figures of the accompanying drawings.

FIG. 1 illustrates the graphical output of a treatment planning software displaying a CT slice of a spine containing manually delineated dose isocontour constraint points.

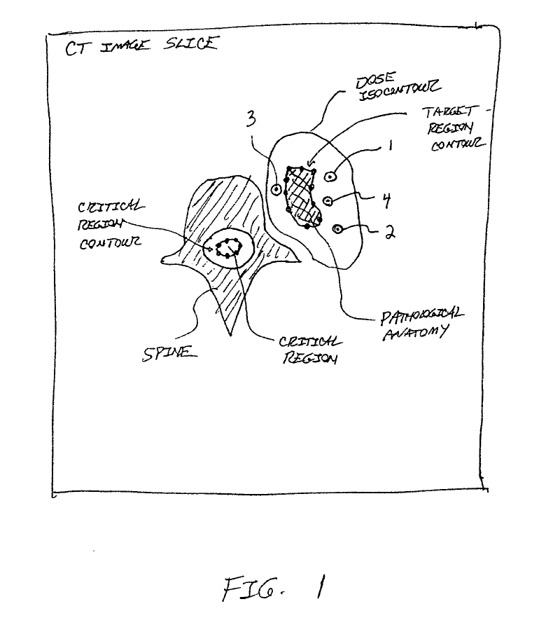

FIG. 2A illustrates one embodiment of automatically generating an optimized dose isocontour.

FIG. 2B illustrates one embodiment of an automatic dose isocontour optimization process.

FIG. 3 illustrates one embodiment of generating a VOI using a target contour and a dose isocontour.

FIG. 4 illustrates 2-dimensional view representing one of the layers of the overlaid bit wise dose mask.

FIG. 5 illustrates a 2-dimensional perspective of radiation beams directed at a target region according to a treatment plan.

FIG. 6 illustrates one embodiment of an optimization process utilizing an iterative routine.

FIG. 7 illustrates a medical diagnostic imaging system including embodiments of the present invention.

### DETAILED DESCRIPTION

In the following description, numerous specific details are set forth such as examples of specific systems, components, methods, etc. in order to provide a thorough understanding of the present invention. It will be apparent, however, to one skilled in the art that these specific details need not be employed to practice the present invention. In other instances, well-known components or methods have not been described in detail in order to avoid unnecessarily obscuring the present invention.

Embodiments of the present invention include various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software.

Embodiments of the present invention may be provided as a computer program product, or software, that may include a machine-readable medium having stored thereon instructions, which may be used to program a computer system (or other electronic devices) to perform a process. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or other type of medium suitable for storing electronic instructions.

Embodiments of the present invention may also be practiced in distributed computing environments where the machine-readable medium is stored on and/or executed by more than one computer system. In addition, the information transferred between computer systems may either be pulled or pushed across the communication medium connecting the computer systems, such as in a remote diagnosis or monitoring system. In remote diagnosis or monitoring, a user may utilize embodiments of the present invention to diagnose or monitor a patient despite the existence of a physical separation between the user and the patient. In addition, the treatment delivery system may be remote from the treatment planning system.

Some portions of the description that follow are presented in terms of algorithms and symbolic representations of operations on data bits that may be stored within a memory and operated on by a processor. These algorithmic descriptions and representations are the means used by those skilled in the art to effectively convey their work. An algorithm is generally conceived to be a self-consistent sequence of acts leading to a desired result. The acts are those requiring manipulation of quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, parameters, or the like.

A volume of interest (VOI) may be defined as a set of planar, closed polygons. The coordinates of the polygon vertices are defined as the x/y/z offsets in a given unit from the image origin. Once a VOI has be defined, it may be represented as a bit wise mask overlaid on the image, so that each bit is zero or one according to whether the corresponding image volume pixel (voxel) is contained within the VOI represented by that bit.

It should be noted that although discussed at times herein in regards to inverse planning, the methods herein may also be used with a mixed planning in which part of the treatment dose is generated by isocenters placed using forward planning and part generated by individual beams during inverse planning.

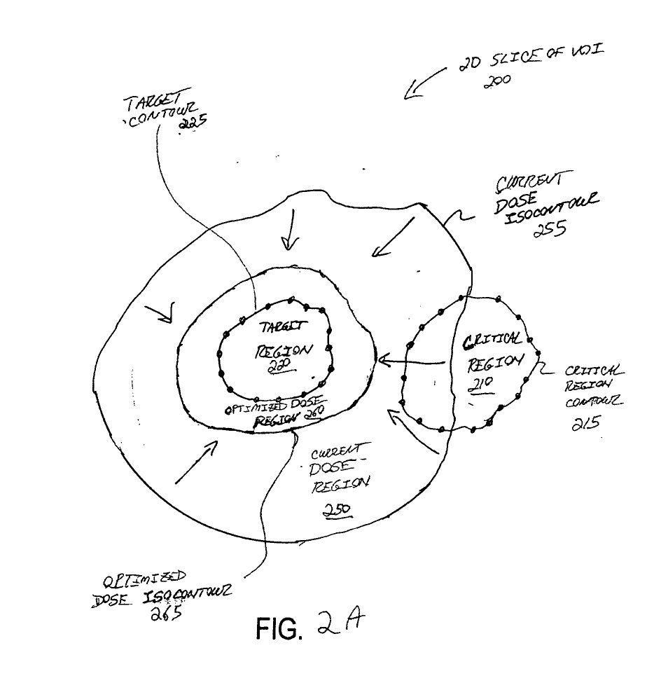

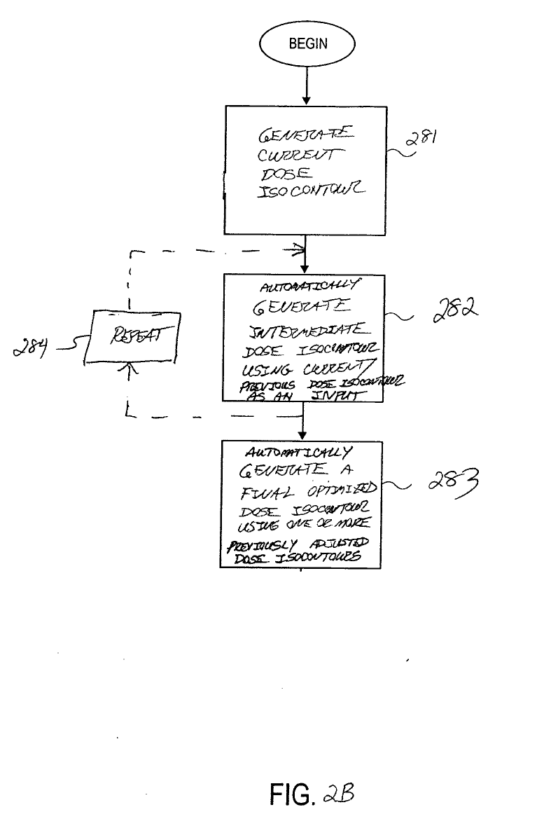

FIG. 2A illustrates one embodiment of automatically generating an optimized dose isocontour. Any one of various treatment planning software packages known in the art may be used to import 3-D images from a diagnostic imaging source, for example, CT. CT imaging provides a 3-dimensional model of a VOI generated from a collection of CT slices and, thereby, the volume requiring treatment can be visualized in three dimensions. FIG. 2A shows an example of a 2-dimensional slice 200 through a VOI (i.e., 3 dimensional volume containing dose isocontour region, target region and critical region), which may represent the displayed output (e.g., CT slice with graphical tool overlay) from treatment planning software. The 2D slice 200 includes a critical region 210 having a critical region contour 215, a target (e.g., tumor) region 220 having a target contour 225, a current dose region 250 having a current dose isocontour 255, and an optimized dose region 260 having an optimized dose isocontour 265. In one embodiment, current dose isocontour 255 represents a given dose percentage (e.g., 60%, 70%, 80%, etc.) of a specified dose constraint for the target region 220. Although a critical region is discussed herein, in an alternative embodiment, the optimized dose isocontour may be automatically generated without the existence and/or input of a critical region.

In one embodiment, the contours of FIG. 2A may be generated using inverse planning whereby dose constraints such as the minimum target (e.g., tumor or lesion) region 220 dose and the maximum dose to region(s) outside of the target region 220 (e.g., healthy tissues) are specified by a user, and then treatment planning software selects the direction, distance, and total number and energy of the beams that is used to implement the treatment plan according to the provided dose constraints. That is, a radiation source is positioned in a sequence calculated to localize the radiation dose into the VOI that as closely as possible conforms to target region 220, while avoiding exposure of regions outside of target region 220. The treatment planning software then produces an inverse treatment plan, relying on the positional capabilities of the radiation treatment system, to meet dose constraints as close as possible.

FIG. 2B illustrates one embodiment of an automatic dose isocontour optimization process. The process may begin with either the user or the treatment planning software generating a current dose isocontour 255, step 281. Current dose isocontour 225 may be generated by the user from visual inspection of the target and critical region(s) one or more 2D slices (e.g., such as 2D slice 200). Alternatively, the current dose isocontour 255 may be generated by treatment planning software based on the delineation of the target region 220 and the critical region 210. The generation of a dose isocontour is known in the art; accordingly a more detailed description is not provided.

Ideally, the current dose contour 255 for 2D slice 200, as well as for the other slices in the VOI, should exactly match the target (e.g., tumor or lesion) contour 225 over its 3 dimensional volume. In actuality, an exact match may not be possible. As such, a given inverse plan developed by the treatment planning software may be unsatisfactory because of lack of conformality, i.e., the current dose isocontour 255 representing the given dose percentage does not fit tightly enough to the boundary of the target contour 225.

In such a situation, the current dose isocontour 255 may be adjusted such that it is brought closer (as represented by the approximately radial arrows in FIG. 2A) to the target contour 225 resulting in a more optimized dose isocontour 265. Optimized dose isocontour 265 may be automatically generated through an iterative routine that receives the current dose isocontour as an input to the routine. Such an optimization process adjusts the current dose isocontour 255 to the more optimized dose isocontour 265. In one embodiment, the adjustment may generate a final optimized dose isocontour 265. In an alternative embodiment, the adjustment may be repeated one or more times, step 284, to generate additional intermediate dose isocontours, using a previously adjusted dose isocontour as an input, in an iterative manner to generate the final optimized dose isocontour 265, step 283.

The optimized dose isocontour 265 is automatically generated in that it does not require (but does not preclude) user intervention in the optimization process after the initial constraints are input into the optimization process. For example, the user may be prompted by the treatment planning software to select whether automatic generation of a more conformal isocontour is desired; the user may be provided the option of manually assisting the automation; the user may be able to change one or more constraints during the optimization process; etc.

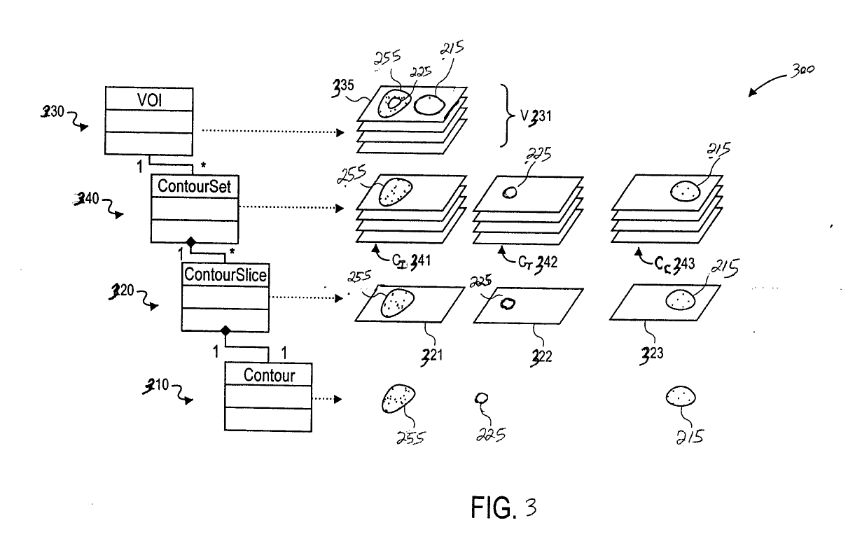

FIG. 3 illustrates one embodiment of generating a VOI using a target contour and a dose isocontour. The VOI may be represented by architecture 300 using, for example, a four-tier structure in a UML graph. UML is a graphical language for visualizing, specifying, constructing and documenting artifacts of a software-intensive system. The UML offers a standard way to write programming language statements, database schemas, and software components. UML is well known in the art; accordingly, a more detailed discussion is not provided herein.

VOI architecture 300 includes a contour tier 310, a contour slice tier 320, a contour set tier 340 and a VOI tier 330. In this illustrated example, architecture 300 has three contour sets 341-343 and three contour slices 321-324 for ease of discussion. Each of the contour slices 321-324 includes a corresponding contour being dose isocontour 225, target contour 225 and critical region contour 215, respectively. A series of Boolean operators may be used to merge the contour sets describing the VOI. Target region 220 (C_{T}) is classified as a hole or cavity structure within a solid structure of the dose region 250 (C_{I}) (and ultimately optimized dose isocontour 265). The solid contour set 255 represent voxels that fall within the current dose region 250. While the cavity contour set 225 represents voxels that are within the target region 220. Critical region 210 may also be treated as a solid contour set (C_{C}) representing voxels that are within critical region 210.

The VOI (V) 231 may then be represented by using the Boolean OR operator (∪):
V=C_{I}∪C_{C} (a)

If a VOI contains one solid body (C_{I}) that has a cavity (C_{T}) inside, then the VOI could be represented suing the Boolean AND operator (∩): V=C_{I}∩\overline{C_{T}}. It should be noted that the solid bodies are illustrated and discussed with single cavities therein only for ease of explanation, and the methods discussed herein may be used with solid bodies having multiple cavities therein. The VOI 331 may then be represented by using the Boolean NOT operator:
V=(C_{I}∪C_{C})∩\overline{C_{T}} (b)

It should be noted that the merged contour sets do not all need to be in the same plane as each other. For example, a solid region defined in the axial direction may be merged with a cavity defined in the sagittal direction. Some anatomical locations are much better viewed in one plane than another. As such, it may be desirable to utilize images taken in different planes. Using the method discussed above with respect to FIG. 2A, a solid contour set for a region imaged in one (e.g., axial) direction may be merged with a solid and/or cavity contour set defined region in a different (e.g., sagittal) direction. In addition, the Boolean operations discussed above may also be used to define a VOI having a branch. As such, in an alternative embodiment, C_{I} and C_{C} may represent branches of a larger connected region in the VOI.

For every iteration of the optimization process, the adjusted, or intermediate, dose isocontour is fed back as input into the VOI 331 as the solid body (C_{I}) with the inner cavity C_{T} of target region 220 remaining constant.

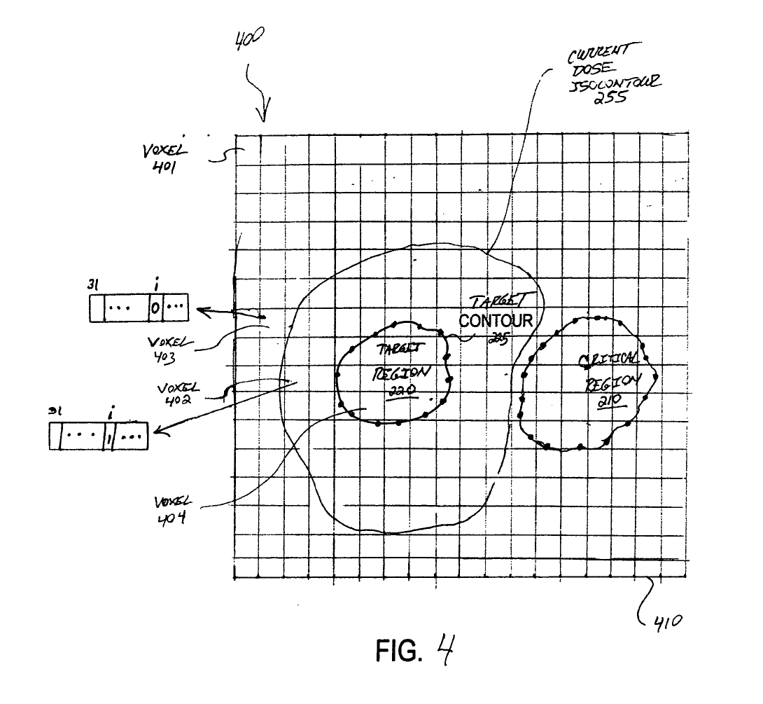

In one embodiment, after VOI 231 has be defined using architecture 300, it may be represented as a dose contour mask (e.g., bit-wise) overlaid on the regions, so that each bit is zero or one according to whether the corresponding image voxel is contained within the dose isocontour, as illustrated by a 2D representation in FIG. 4. The dose contour mask is overlaid on the regions so that at any voxel in the overlay, the dose that will be applied at a particular voxel location with a current treatment plan is known.

FIG. 4 illustrates 2-dimensional view representing one of the layers of the overlaid dose contour mask. The entire VOI mask (i.e., layer 400 of FIG. 4 together with the other non-illustrated layers) is a volume representation of all user defined VOIs that is geometrically considered as a cuboid composed of many small cuboids of approximately the same size (i.e., the voxels). In this embodiment, every voxel (e.g., voxels 401, 402, 403, 404, etc.) contains 32 bits. Alternatively, other number of bit words may be used for a voxel. One bit, or more, of a voxel (e.g., the iₜₕ bit) may be used to represent if the voxel is covered by a VOI that is defined by the index of the bit. At every voxel location (e.g., voxel 401), the bit value will be either a “1” or a “0” indicating whether a particular voxel is part of the dose isocontour. For example, a “1” bit value may be used to indicate a voxel is within the dose isocontour volume (as conceptually illustrated by the “1” for iₜₕ bit of voxel 402). If, for example, the voxel bit is a “0” (as conceptually illustrated by the “0” for the iₜₕ bit of voxel 403), the treatment planning algorithm ignores the dose constraints for that corresponding dose voxel. The VOI mask volume serves as an interface between the VOI structures and the rest of an imaging system's functions such as, for examples, a 3-D VOI visualization and dose calculation in treatment planning.

The dose calculation process in the treatment planning algorithm considers a set of beams that are directed at the target region 220. In one embodiment, the treatment planning algorithm is used with a radiation source that has a collimator that defines the width of the set of beams that is produced. For each target region 220, for example, the number of beams, their sizes (e.g., as established by the collimator), their positions and orientations are determined. Having defined the position, orientation, and size of the beams to be used for planning, how much radiation should be delivered via each beam is also determined. The total amount of radiation exiting the collimator for one beam is defined in terms of Monitor Units (MU). Because the intensity of the radiation source is constant, the MU is linearly related to the amount of time for which the beam is enabled. The radiation dose absorbed (in units of cGy) by tissue in the path of the beam is also linearly related to the MU. The absorbed dose related to a beam is also affected by the collimator size of the beam, the amount of material between the collimator and the calculation point, the distance of the collimator from the calculation point, and the distance of the calculation point from the central axis of the beam.

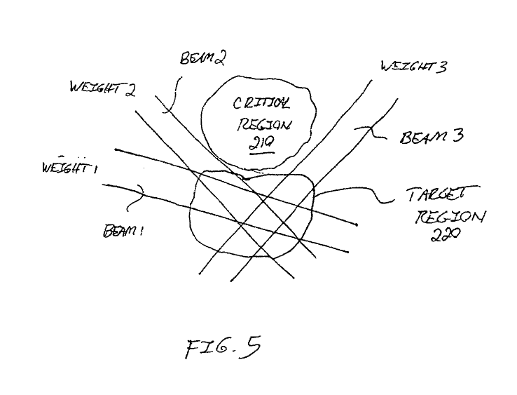

FIG. 5 illustrates a 2-dimensional perspective of radiation beams of a radiation treatment system directed at a target region according to a treatment plan. It should be noted that 3 beams are illustrated in FIG. 5 only for ease of discussion and that an actual treatment plan may include more, or fewer, than 3 beams. Furthermore, although the 3 beams appear to intersect in the 2-dimensional perspective of FIG. 5, the beams may not intersect in their actual 3-dimensional space. The radiation beams need only intersect with the target volume and do not necessarily converge on a single point, or isocenter, within the target

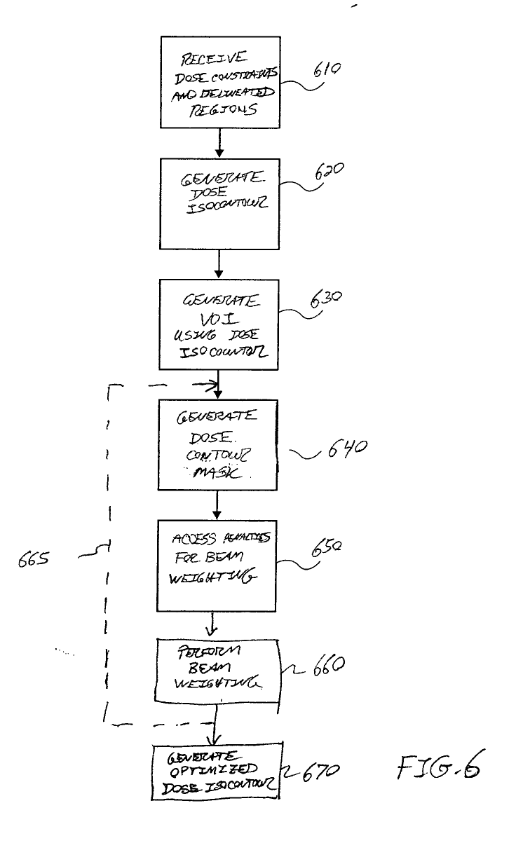

FIG. 6 is a flow chart illustrating one embodiment of an optimization process utilizing an iterative routine. In this embodiment, the optimization process utilizes an iterative routine that enables alterations to treatment plan without requiring re-initialization of the optimization process.

In one embodiment, the treatment planning algorithm receives as input from a user, step 610, the delineated target region 220 and any critical region 210 on one or more slices of a CT image; and (2) dose constraints defining the minimum and maximum doses for target region 220 and the maximum dose for the critical region 210. It should be noted that additional dose constraints for additional regions may also be provided. The delineation of the regions and the dose constraints may be performed in any order.

The user or the treatment planning algorithm assigns an arbitrary weighting to each of one or more beams of the radiation treatment system. This weighting may be determined using an algorithm designed to give a suitable “start point” for planning, may be randomly chosen, or may simply be a constant weighting for each beam. Then, an initial dose isocontour (e.g., current dose isocontour 255) is generated by the treatment planning software for a given dose percentage (e.g., 60%, 70%, 80%, etc.) of the maximum dose within the dose calculation grid 410. As previously mentioned, the generation of a dose isocontour is known in the art; accordingly, a more detailed description is not provided.

Next, a VOI, step 630, and its corresponding dose contour mask, step 640, are generated using the initial dose isocontour from step 620 with the methods discussed above in relation to FIGS. 3 and 4.

Then, the treatment planning algorithm performs beam weighting of each one or more beams of the radiation treatment system to be used in the treatment plan according to the inputs provided by the user above. If a voxel bit from dose contour mask 400 is a “0“, the planning algorithm ignores the dose constraints for that corresponding dose voxel. However, if a voxel bit from dose contour mask 400 has a “1” bit value, then determine whether any penalties should be accessed when performing beam weighting based on the dose constraints for that dose voxel, step 650.

In one particular embodiment, to begin the beam weighting, step 660, an assumption may be made that the size and trajectory of the beam set has been defined. Let the beam set be (Bᵢ; 1≦i≦N), where N≈500. Each of the beams illustrate in FIG. 5 has a weight (e.g., a number of MU assigned to the beam, or how long a beam will be maintained on) associated with it The weight in MU of each beam is designated by wᵢ. The delineated regions are represented as objects Tᵢ (derived from the, e.g., bit wise, dose contour mask formed by layer 400 of FIG. 4 together with the other non-illustrated layers of the mask), with corresponding minimum and maximum allowed dose minⱼ and maxⱼ, and critical structures (critical region 210) Cⱼ, with corresponding maxⱼ defined. Each region has an integer priority pⱼ ∈ [0,100] defining the relative importance of the dose constraints applied to that region. For each beam, a dose value mask is created. The dose value mask provides a linked list of floating point values and positions dᵢ(r) where r is the position within the dose calculation volume, and dᵢ is the dose in cGy delivered to r by beam i when wᵢ is set to unity. Thus, the total dose at r is given by:

$$D ( r ) = {\sum }_{i = 1}^{N} {w}_{i} {d}_{i} ( r ) . \qquad ( 1 )$$

For each Bᵢ, we define a beam value υᵢ, where

$${υ}_{i} = \frac{{\sum }_{j} \sum r ∈ {T}_{j} {ⅆ}_{i} ( r )}{\sum {ⅆ}_{i} ( r )} , \qquad ( 2 )$$

The beam value is the ratio of dose delivered into target region 220 to total dose delivered. To define the initial set of wᵢ for optimization, we set wᵢ<υᵢ, ∀i. The maximum dose within the dose calculation volume, Dₘₐₓ, is computed and the beam weights renormalized so that the new maximum dose is equal to the largest of the maximum dose constraints, maxⱼ. Hence, this provides:
wᵢ=υᵢsup(maxⱼ)/Dₘₐₓ. (3)

At one iteration of the treatment planning algorithm, the optimization process looks at all of the dose values in the dose volume and determine if the target region 220 and critical region 210 are within the dose constraints. For example, suppose the dose in the target region 220 is specified to be equal to or greater than 2000 cGy and less than or equal to 2500 cGy. Suppose, the current dose value at grid location for voxel 404 of FIG. 4 is 1800 cGy, then the optimization process determines that, at the current beam weightings, the dose value at voxel 404 is 200 cGy short in order to satisfy the treatment plan constraints.

Given the initial weights, the optimization process then alters the beam weights so that the treatment solution is closer to meeting the provided dose constraints. First, a set of Δwᵢ, the amount by which each beam weight may be changed, is defined:

$$\begin{matrix}Δ {w}_{i} = {Δ}^{( 0 )} {w}_{i} \\ = \frac{s}{4 N} {\sum }_{i = 1}^{N} {w}_{i} , ∀ i\end{matrix} \qquad ( 4 )$$

where s is the search resolution, having an initial value of 1.

The optimization process iterates through one or more of the beams and for each of the beams, if a beam weight is increased or decreased by a certain amount, determines the resulting dose distribution from such a change (i.e., how such a change alters the amount of violation of the treatment plan constraints). For example, an increase in one or more of the beam weights may typically help in achieving the constraint in the target (e.g., tumor) region but, depending on the location of the beam, it may also hurt in the critical region due to a possible resulting increase of dose above the maximum value in the critical region.

The optimization process traverses the volume of interest, adds up all the penalties that are incurred by the increase in a beam weight, adds up all the penalties that are incurred by the decreasing the beam weight (e.g., under-dosing the target region), and then provides a result. In one embodiment, a multiplier may be used with each penalty to stress the importance of one constraint (e.g., minimum dose value in the target region) versus another constraint (e.g., maximum dose value in the target region). For example, it may more important to achieve a minimum dose value than to stay under the maximum dose value in the target region.

The optimization process then updates the dose and goes on to the next beam and repeats the process until it has made its way through the beam set. The optimization process then reaches a stage where it has looked at all of the different weights for each of the beams at the different dose levels and selects the beam weight that provides the optimal resulting dose values in both the target region and critical region.

More particularly, in one embodiment, the iterative optimization process proceeds as follows: Iterate over the beams in decreasing order of υᵢ. For each beam Bⱼ, calculate Pⱼ⁺ and Pⱼ⁻, the relative penalties for respectively increasing or decreasing wⱼ, that are defined as:

$${P}_{j}^{+} = {\sum }_{i} \frac{{p}_{i}}{{V}_{i}} {\sum }_{r ∈ {T}_{i} ⋃ r ∈ {C}_{i}} Δ {w}_{j} {d}_{j} ( r ) max ( 0 , min ( 1 , \frac{D ( r ) + Δ {w}_{j} {ⅆ}_{j} ( r ) - {max}_{i}}{Δ {w}_{j} {ⅆ}_{j} ( r )} ) ) - {\sum }_{i} \frac{{p}_{i}}{{V}_{i}} {\sum }_{r ∈ {T}_{i}} Δ {w}_{j} {d}_{j} ( r ) max ( 0 , min ( 1 , \frac{{min}_{i} - D ( r )}{Δ {w}_{j} {d}_{j} ( r )} ) ) , \\ and$$

$${P}_{j}^{-} = {\sum }_{i} \frac{{p}_{i}}{{V}_{i}} {\sum }_{r ∈ {T}_{i}} Δ {w}_{j} {d}_{j} ( r ) max ( 0 , min ( \frac{{min}_{i} - D ( r ) + Δ {w}_{j} {ⅆ}_{j} ( r )}{Δ {w}_{j} {ⅆ}_{j} ( r )} ) ) - {\sum }_{i} \frac{{p}_{i}}{{V}_{i}} {\sum }_{r ∈ {T}_{i} ⋃ r ∈ {C}_{i}} Δ {w}_{j} {d}_{j} ( r ) max ( 0 , min ( 1 , \frac{D ( r ) - {max}_{i}}{Δ {w}_{j} {d}_{j} ( r )} ) ) ,$$

where Vᵢ is the volume in mm³ of region i. Hence, the penalty for this beam is the sum of the additional amount of over-dosing and under-dosing that would be created by the change in the beam, weighted by the priorities of the different regions and normalized according to the region volumes. If Pⱼ⁻ and Pⱼ⁺ are both positive, wⱼ is kept the same, otherwise change wⱼ=wⱼ±Δwⱼ according to whichever of Pⱼ⁻ and Pⱼ⁺ is smaller. If the previous iteration moved wⱼ in the same direction as this iteration, the following is set:
Δwⱼ=wⱼ+Δ⁽⁰⁾wⱼ, (5)
else set:
Δwⱼ=Δ⁽⁰⁾wⱼ. (6)

The change in dose according to Δwⱼ is computed and applied to the dose volume before the optimization process moves on to a next beam, because a correct decision on how to change the beam weight assumes an up-to-date view of the dose including change sin previous wᵢ. If all wⱼ remained unchanged by the current iteration, s is reduced by a factor of 2.

At this stage, the treatment planning software generates a more optimized dose isocontour that may be displayed to the user, updates the bit dose contour mask 400 in step 640 (e.g., assigns a “0” to one or more voxels) to indicate whether a particular voxel is now outside of the dose isocontour, and then the above beam weighting process may be repeated. In one embodiment, after a certain number of iterations (indicated by the dashed line 665 of FIG. 6) have been executed, the optimization process terminates to generate a final optimized dose isocontour (e.g., optimized dose isocontour 265), step 670. Each new iteration starts with the solution given by a previous iteration.

The optimization process described above may provide feedback to the user via an update to the dose isocontours and/or dose volume histograms (DVHs), after each iteration in the optimization process. Accordingly, it is easy to make small modifications to the plan without going through the entire solution process.

In an alternative embodiment, the optimization algorithm may perform convex optimization via, for example, a Simplex algorithm, in an attempt to find an MU setting for all beams so that the dose constraints are nowhere violated. A Simplex algorithm is known in the art; accordingly, a detailed description is not provided. Alternatively, other iterative and non-iterative optimization algorithms may be used.

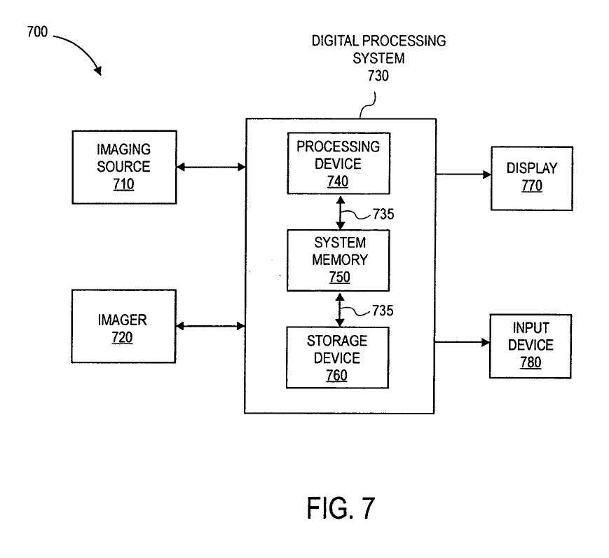

FIG. 7 illustrates one embodiment of medical diagnostic imaging system in which features of the present invention may be implemented as a treatment planning system. The medical diagnostic imaging system may be discussed below at times in relation to CT imaging modality only for ease of explanation. However, other imaging modalities may also be used.

Medical diagnostic imaging system 700 includes an imaging source 710 to generate a beam (e.g., kilo voltage x-rays, mega voltage x-rays, ultrasound, MRI, etc.) and an imager 720 to detect and receive the beam generated by imaging source 710. In an alternative embodiment, system 700 may include two diagnostic X-ray sources and/or two corresponding image detectors. For example, two x-ray sources may be nominally mounted angularly apart (e.g., 90 degrees apart or 45 degree orthogonal angles) and aimed through the patient toward the imager(s). A single large imager, or multiple imagers, can be used that would be illuminated by each x-ray imaging source. Alternatively, other numbers and configurations of imaging sources and imagers may be used.

The imaging source 710 and the imager 720 are coupled to a digital processing system 730 to control the imaging operation. Digital processing system 730 includes a bus or other means 735 for transferring data among components of digital processing system 730. Digital processing system 510 also includes a processing device 740. Processing device 740 may represent one or more general-purpose processors (e.g., a microprocessor), special purpose processor such as a digital signal processor (DSP) or other type of device such as a controller or field programmable gate array (FPGA). Processing device 740 may be configured to execute the instructions for performing the operations discussed above, such as the VOI generation of FIG. 3, the bit mask generation of FIG. 4, and the treatment planning algorithm for the optimization process of FIG. 6.

Digital processing system 730 may also include system memory 750 that may include a random access memory (RAM), or other dynamic storage device, coupled to bus 735 for storing information and instructions to be executed by processing device 740. System memory 750 also may be used for storing temporary variables or other intermediate information during execution of instructions by processing device 740. System memory 750 may also include a read only memory (ROM) and/or other static storage device coupled to bus 735 for storing static information and instructions for processing device 740.

A storage device 760 represents one or more storage devices (e.g., a magnetic disk drive or optical disk drive) coupled to bus 735 for storing information and instructions. Storage device 760 may be used for storing instructions for performing the steps discussed herein.

Digital processing system 730 may also be coupled to a display device 770, such as a cathode ray tube (CRT) or liquid crystal display (LCD), for displaying information (e.g., 3D representation of the VOI) to the user. An input device 780, such as a keyboard, may be coupled to digital processing system 730 for communicating information and/or command selections to processing device 740. One or more other user input devices, such as a mouse, a trackball, or cursor direction keys for communicating direction information and command selections to processing device 740 and for controlling cursor movement on display 770 may also be used.

It will be appreciated that the digital processing system 730 represents only one example of a system, which may have many different configurations and architectures, and which may be employed with the present invention. For example, some systems often have multiple buses, such as a peripheral bus, a dedicated cache bus, etc.

One or more of the components of digital processing system 730 may form a treatment planning system. The treatment planning system may share its database (e.g., stored in storage device 760) with a treatment delivery system, so that it is not necessary to export from the treatment planning system prior to treatment delivery. The treatment planning system may also include MIRIT (Medical Image Review and Import Tool) to support DICOM import (so images can be fused and targets delineated on different systems and then imported into the treatment planning system for planning and dose calculations), expanded image fusion capabilities that allow the user to treatment plan and view isodose distributions on any one of various imaging modalities (e.g., MRI, CT, PET, etc.).

In one embodiment, the treatment delivery system may be an image guided robotic based linear accelerator (LINAC) radiation treatment (e.g., for performing radiosurgery) system, such as the CyberKnife® system developed by Accuray, Inc. of California. In such a system, the LINAC is mounted on the end of a robotic arm having multiple (e.g., 5 or more) degrees of freedom in order to position the LINAC to irradiate the pathological anatomy with beams delivered from many angles in an operating volume (e.g., sphere) around the patient. Treatment may involve beam paths with a single isocenter, multiple isocenters, or with a non-isocentric approach (i.e., the beams need only intersect with the pathological target volume and do not necessarily converge on a single point, or isocenter, within the target). Treatment can be delivered in either a single session (mono-fraction) or in a small number of sessions (hypo-fractionation) as determined during treatment planning. Treatment may also be delivered without the use of a rigid external frame for performing registration of pre-operative position of the target during treatment planning to the intra-operative delivery of the radiation beams to the target according to the treatment plan.

Alternatively, another type of treatment delivery system may be used, for example, a gantry based (isocentric) intensity modulated radiotherapy (IMRT) system. In a gantry based system, a radiation source (e.g., a LINAC) is mounted on the gantry in such a way that it rotates in a plane corresponding to an axial slice of the patient. Radiation is then delivered from several positions on the circular plane of rotation. In IMRT, the shape of the radiation beam is defined by a multi-leaf collimator that allows portions of the beam to be blocked, so that the remaining beam incident on the patient has a pre-defined shape. The resulting system generates arbitrarily shaped radiation beams that intersect each other at the isocenter to deliver a dose distribution to the target. In IMRT planning, the optimization algorithm selects subsets of the main beam and determines the amount of time for which the subset of beams should be exposed, so that the dose constraints are best met.

In other embodiments, yet other types of treatment delivery systems may be used, for example, a stereotactic frame system such as the GammaKnife®, available from Elekta of Sweden. With such a system, the optimization algorithm (also referred to as a sphere packing algorithm) of the treatment plan determines the selection and dose weighting assigned to a group of beams forming isocenters in order to best meet provided dose constraints.

It should be noted that the methods and apparatus described herein are not limited to use only with medical diagnostic imaging. In alternative embodiments, the methods and apparatus herein may be used outside of the medical technology field, such as non-destructive testing of materials (e.g., motor blocks in the automotive industry and drill cores in the petroleum industry) and seismic surveying.

In the foregoing specification, the invention has been described with reference to specific exemplary embodiments thereof. It will, however, be evident that various modifications and changes may be made thereto without departing form the broader spirit and scope of the invention as set forth in the appened claims. The specification and drawings are, accordingly, to be regarded in an illustrative sense rather than a restrictive sense.

What is claimed is:

1. A method, comprising:
generating a first dose isocontour; and
automatically generating at least a second dose isocontour using the first dose isocontour, wherein the second dose isocontour is optimized with respect to the first dose isocontour.

2. The method of claim 1, wherein automatically generating further comprises:
automatically generating a third dose isocontour using the second dose isocontour as an input parameter, wherein the third dose isocontour is optimal with respect to at least one of the first and second dose isocontours.

3. The method of claim 1, wherein the first dose isocontour is a current dose isocontour, and wherein the current dose isocontour is generated using a previous dose isocontour.

4. The method of claim 3, wherein the at least second dose isocontour is automatically generated without requiring user intervention in the method after the first dose isocontour is generated.

5. The method of claim 1, wherein the at least second dose isocontour is automatically generated without requiring user intervention in the method after the first dose isocontour is generated.

6. A method, comprising:
(a) generating a volume of interest using a dose isocontour;
(b) generating a dose contour mask using the volume of interest;
(c) determining a treatment plan using the dose contour mask; and
(d) generating an optimized dose isocontour from the treatment plan, the optimized dose isocontour being optimized with respect to the dose isocontour.

7. The method of claim 6, further comprising:
receiving one or more delineated regions and a dose constraint for each of the one or more delineated regions; and
generating the dose isocontour using the delineated regions and the dose constraint for each of the one or more delineated regions.

8. The method of claim 7, wherein the optimized dose isocontour is automatically generated without requiring user intervention in the method after the dose isocontour is generated.

9. The method of claim 6, further comprising repeating steps (a) through (d) one or more times by providing a previously generated optimized dose isocontour as the dose isocontour used to generate the volume of interest in step (a).

10. The method of claim 6, wherein determining a treatment plan comprises:
accessing penalties for beam weighting using the dose contour mask; and
performing beam weighting using the penalties.

11. The method of claim 6, wherein generating a volume of interest comprises:
generating a first contour set including a first dose isocontour defining a first solid body;
generating a second contour set including a target contour defining a cavity within the solid body; and
merging the first contour set and the second contour set using Boolean operators.

12. The method of claim 11, wherein merging comprises performing a Boolean AND operation on the first contour set with a Boolean NOT of the second contour set.

13. A method of generating a volume of interest, comprising:
generating a first contour set including a first dose isocontour defining a first solid body;
generating a second contour set including a target contour defining a cavity within the solid body; and
merging the first contour set and the second contour set using Boolean operators.

14. The method of claim 13, wherein merging comprises performing a Boolean AND operation on the first contour set with a Boolean NOT of the second contour set.

15. The method of claim 13, wherein the first contour set is in a first plane being different than a second plane of the second contour set.

16. The method of claim 13, further comprising:
generating, using the first dose isocontour, a third contour set including a second dose isocontour defining a second solid body.

17. A machine readable medium having instructions stored thereon, which when executed by a processor, cause the processor to perform the following comprising:
(a) generating a volume of interest using a dose isocontour;
(d) generating a dose contour mask using the volume of interest;
(e) determining a treatment plan using the dose contour mask; and
(d) generating an optimized dose isocontour from the treatment plan, the optimized dose isocontour being optimized with respect to the dose isocontour.

18. The machine readable medium of claim 17, wherein the instructions further cause the processor to perform the following comprising:
repeating steps (a) through (d) one or more times by providing a previously generated optimized dose isocontour as the dose isocontour used to generate the volume of interest in step (a).

19. The machine readable medium of claim 17, wherein determining a treatment plan comprises:
accessing penalties for beam weighting using the dose contour mask; and
performing beam weighting using the penalties.

20. The machine readable medium of claim 17, wherein generating a volume of interest comprises:
generating a first contour set including a first dose isocontour defining a first solid body;
generating a second contour set including a target contour defining a cavity within the solid body; and
merging the first contour set and the second contour set using Boolean operators.

21. The machine readable medium of claim 20, wherein merging comprises performing a Boolean AND operation on the first contour set with a Boolean NOT of the second contour set.

22. An apparatus, comprising:
an imager to generate a plurality of image slices; and
a processor coupled to the imager to receive the plurality of image slices, wherein the processor is configured to (a) generating a volume of interest using a dose isocontour, (b) generating a dose contour mask using the volume of interest, (c) determining a treatment plan using the dose contour mask, and (d) generating an optimized dose isocontour from the treatment plan, the optimized dose isocontour being optimized with respect to the dose isocontour.

23. The apparatus of claim 22, further comprising a storage device coupled to the processor to store the plurality of image slices.

24. The apparatus of claim 22, wherein the processor is configured to repeat steps (a) through (d) one or more times by providing a previously generated optimized dose isocontour as the dose isocontour used to generate the volume of interest in step (a).

24. The apparatus of claim 22, wherein the processor is configured to merge the first contour set and the second contour set by performing a Boolean AND operation on the first contour set with a Boolean NOT of the second contour set in order to generate the volume of interest.

25. The apparatus of claim 22, wherein the processor is configured to perform a Boolean AND operation on the first contour set with a Boolean NOT of the second contour set to merge the first contour set and the second contour set.
